(19) United States
(12) Patent Application Publication
(10) Pub. No.: US 2013/0092762 A1
(43) Pub. Date: Apr. 18, 2013

(54) WATERING NOZZLE

(71) Applicant: Takagi Co., Ltd., Kitakyushu-shi (JP)

(72) Inventors: Naoki Kikuchi, Soka-shi (JP); Yosuke Oda, Kitakyushu-shi (JP)

(73) Assignee: TAKAGI CO., LTD., Kitakyushu-shi (JP)

(21) Appl. No.: 13/633,727

(22) Filed: Oct. 2, 2012

(30) Foreign Application Priority Data
Oct. 12, 2011 (JP) 2011-224608

(51) Int. Cl. B05B 1/30

(52) U.S. Cl. 239/569

(57) ABSTRACT

A watering nozzle including an outer casing having a water discharge screen and an inner casing having a supply passage is provided. The water discharge screen includes an inner region and an outer circumferential region. The outer casing includes a first passage communicating with the inner region and a second passage communicating with the outer circumferential region. Relative rotation between the outer casing and the inner casing enables the outer casing to make a relative displacement in the longitudinal direction with respect to the inner casing. The relative displacement enables selection between the first passage and the second passage. A shower hole is provided in the inner region. The discharge flow rate of water from the inner region can change based on the relative displacement.

The present invention claims the benefit of priority from Japanese Patent Application No. 2011-224608 filed on Oct. 12, 2011, the entire content of which is hereby incorporated by reference into this application.

### BACKGROUND OF THE INVENTION

1. Field of the Invention

The present invention relates to a watering nozzle.

2. Description of the Related Art

A watering nozzle is used for various purposes such as horticulture, cleaning, and car washing. Moreover, such a watering nozzle is known, in which water discharge shapes can be selected.

Japanese Examined Patent Application Publication No. 4-39386 (U.S. Pat. No. 4,785,998) discloses a watering nozzle in which a nozzle opening is provided in the center of a perforated plate. In the watering nozzle, spray water or straight water is emitted from the nozzle opening, and shower-shaped or sprinkling-shaped water is emitted from the perforated plate located in the outer circumferential region around the nozzle opening.

Japanese Patent Application Laid-Open No. 2000-37641 discloses a shower head having a center region, an intermediate region, and a circumferential region. In the shower head, selection can be made between water discharge only from the center region, water discharge from the center region and the intermediate region, and water discharge from all of these three regions. This selection is achieved by rotating a water discharge portion.

### SUMMARY OF THE INVENTION

In Japanese Examined Patent Application Publication No. 4-39386, in addition to a shower water shape and a sprinkling water shape, a straight water shape and a spray water shape are implemented, thereby providing many types of water shapes. Thus, a high level of convenience is achieved. However, since shower water is discharged from the outer circumferential region of a screen in a wide range, it is difficult to make a strong shower water discharge or shower water discharge in a narrow range. Moreover, since water does not spread and water is strong in a straight water discharge, a water splash is apt to occur in a case where the water pressure is high. Japanese Patent Application Laid-Open No. 2000-37641 has only three types of shower patterns. Furthermore, since the water discharge flow rate is unable to be adjusted at the shower head, the power of water discharge is reduced when the water discharge region is increased, whereas the power of water discharge is increased when the water discharge region is reduced. Thus, the degree of freedom of adjusting water discharge is low.

It is an object of the present invention to provide a watering nozzle that can implement novel shower water discharge.

A watering nozzle according to the present invention includes an outer casing having a water discharge screen and an inner casing having a supply passage. The water discharge screen has an inner region and an outer circumferential region. The outer casing has a first passage communicating with the inner region, a second passage communicating with the outer circumferential region, and a screw portion. The inner casing has a screw portion. The screw portion of the outer casing and the screw portion of the inner casing form screw coupling. Relative rotation between the outer casing and the inner casing causes the outer casing to make a relative displacement in a longitudinal direction with respect to the inner casing. The relative displacement enables selection between a state in which water in the supply passage goes to the first passage and a state in which water in the supply passage goes to the second passage. A shower hole is provided in the inner region. A discharge flow rate of water from the inner region changes continuously, based on the relative displacement.

Preferably, a shower hole is provided in the outer circumferential region.

Preferably, a discharge flow rate of water from the outer circumferential region changes continuously, based on the relative displacement.

Preferably, the water discharge screen further has an outer edge region located on an outer side of the outer circumferential region. Preferably, the outer edge region has an annular opening. Preferably, the outer circumferential region further has a straight hole. Preferably, the outer casing further has a third passage communicating with the outer edge region and a fourth passage communicating with the straight hole. The relative displacement enables selection between a state in which water in the supply passage goes to the first passage, a state in which water in the supply passage goes to the second passage, a state in which water in the supply passage goes to the third passage, and a state in which water in the supply passage goes to the fourth passage.

Preferably, a discharge flow rate of water from the inner region continuously changes based on the relative displacement. Preferably, a range in which water discharged from the inner region reaches is narrower than a range in which water discharged from the outer circumferential region reaches regardless of a distance which water goes.

The watering nozzle according to the present invention implements novel shower water discharge.

### BRIEF DESCRIPTION OF THE DRAWINGS

FIG. 1 is a perspective view of a watering nozzle according to a first embodiment of the present invention;

FIG. 2 is a front view of the watering nozzle in FIG. 1;

FIG. 3 is a cross sectional view of the tip end portion of the watering nozzle in FIG. 1;

FIG. 4 is a cross sectional view of the tip end portion of the watering nozzle in FIG. 1;

FIG. 5 is a cross sectional view of the tip end portion of the watering nozzle in FIG. 1;

FIG. 6 is a cross sectional view of the tip end portion of the watering nozzle in FIG. 1;

FIG. 7 is a cross sectional view of the tip end portion of the watering nozzle in FIG. 1;

FIG. 8 is a front view of a watering nozzle according to a second embodiment of the present invention;

FIG. 9 is a partially cutaway view of the tip end portion of the watering nozzle in FIG. 8;

FIG. 10 is a partially cutaway view of the tip end portion of the watering nozzle in FIG. 8;

FIG. 11 is a partially cutaway view of the tip end portion of the watering nozzle in FIG. 8;

FIG. 12 is a partially cutaway of the tip end portion of the watering nozzle in FIG. 8;

FIG. 13 is a partially cutaway view of the tip end portion of the watering nozzle in FIG. 8;

FIGS. 14A and 14B are diagrams of the contour shape of a water shape according to an example;

FIG. 15 is a graph of data in an example;

FIG. 16 is a graph of data in an example; and

FIG. 17 is a graph of data in an example.

### DESCRIPTION OF THE PREFERRED EMBODIMENTS

In the following, the present invention will be described in detail based on preferred embodiments appropriately with reference to the drawings.

### First Embodiment

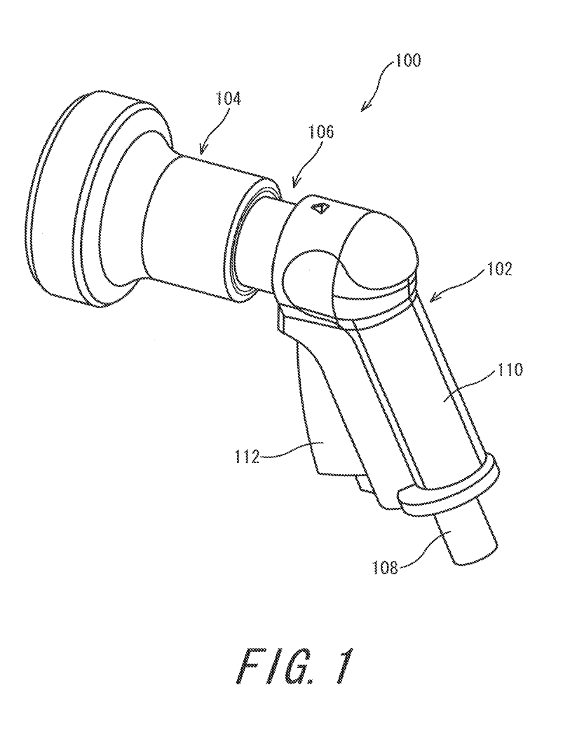

FIG. 1 is a perspective view of a watering nozzle 100 according to a first embodiment of the present invention. The watering nozzle 100 includes a main body 102, an outer casing 104, and an inner casing 106. The main body 102 includes a feed water connecting portion 108, a grip portion 110, and a lever 112. Although not illustrated in the drawing, a water supply pipe that supplies water to the inner casing 106 is disposed in the main body 102. The lever 112 enables selection between water discharge and water shut off. A structure that implements this selection is publicly known. A hose, for example, is connected to the feed water connecting portion 108. Water supplied at a predetermined water supply pressure (a tap water pressure) goes from the hose to the inner casing 106 through the water supply pipe. Generally, the watering nozzle 100 is connected to general running water. A general tap water pressure is equal to or greater than a pressure of 0.05 MPa for a lower limit, and more generally, the tap water pressure is equal to or greater than a pressure of 0.15 MPa for a lower limit, and the upper limit is equal to or less than a pressure of 0.74 MPa. The watering nozzle 100 is preferably used at a tap water pressure in this range. The tap water pressure is relatively lower than a pump water pressure or the like. The watering nozzle 100 can obtain a variety of water shapes as described later even at relatively low tap water pressures.

The outer casing 104 is rotatable with respect to the inner casing 106. This rotation changes the rotational position. The change in the rotational position changes the water shape. The detail of this point will be described later.

The outer casing 104 has a water discharge screen 114. The water discharge screen 114 forms the front surface of the outer casing 104.

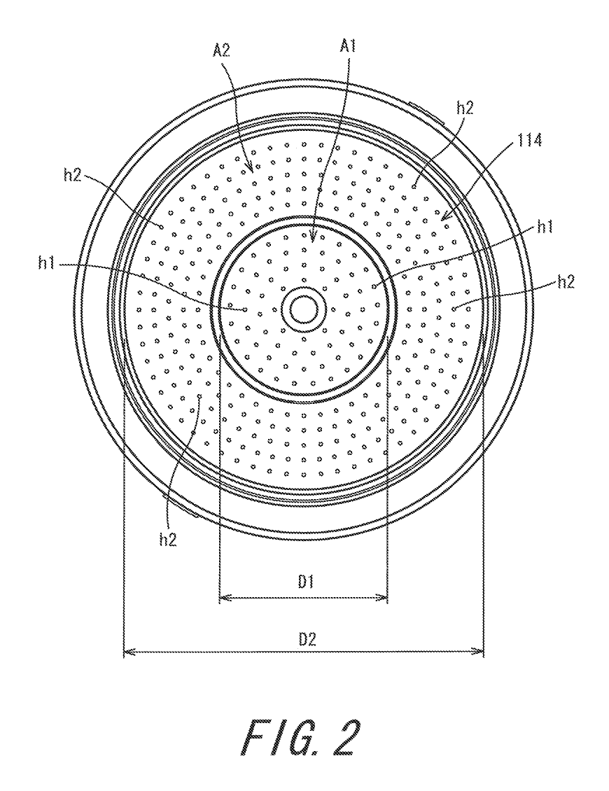

FIG. 2 is a plan view of the water discharge screen 114. The water discharge screen 114 includes an inner region A1 and an outer circumferential region A2. When seen in a plane (FIG. 2), the inner region A1 is a circular region where the diameter is D1. The outer circumferential region A2 is an annular region. The outer circumferential region A2 is located on the outer side (on the outer side in the radial direction) of the inner region A1. The outer diameter of the outer circumferential region A2 is denoted by reference character D2 in FIG. 2. The diameter D2 is the diameter when seen in a plane. Although not illustrated in the drawing, the outer surface of the water discharge screen 114 forms a convex curved surface. The convex curved surface has a spherical shape. The convex curved surface increases a range in which water reaches.

The inner region A1 preferably has a circular shape. However, the inner region A1 may have other shapes, an ellipse or a rectangle, for example. Here, suppose that a distance between two points on the outer edge of the inner region A1 is a clearance L. The clearance L is the length of a line segment having two points at both ends and passing through the centroid of the outer edge. The maximum value of the clearance L is Lmax, and the minimum value of the clearance L is Lmin. In the case where the outer edge of the inner region A1 has a non-circular shape, preferably, the ratio of Lmax/Lmin is equal to or less than 2, more preferably, equal to or less than 1.5, and much more preferably, equal to or less than 1.2. In the inner region A1 in a circular shape, the ratio of Lmax/Lmin is 1.

Preferably, the shape of the inner edge of the outer circumferential region A2 is the same as the shape of the outer edge of the inner region A1 as described above. In this case, more preferably, the inner edge of the outer circumferential region A2 is matched with the outer edge of the inner region A1. Preferably, the outer edge of the outer circumferential region A2 has a circular shape. However, the outer edge of the outer circumferential region A2 may have other shapes, an ellipse or a rectangle, for example. Here, suppose that a distance between two points on the outer edge of the outer circumferential region A2 is a clearance M. The clearance M is the length of a line segment having the two points at both ends and passing through the centroid of the outer edge. The maximum value of the clearance M is Mmax, and the minimum value of the clearance M is Mmin. In the case where the outer edge of the outer circumferential region A2 has a non-circular shape, preferably, the ratio of Mmax/Mmin is equal to or less than 2, more preferably, equal to or less than 1.5, and much more preferably, equal to or less than 1.2. In the outer circumferential region A2 having the outer edge in a circular shape, the ratio of Mmax/Mmin is 1.

The inner region A1 is provided with a plurality of shower holes h1. In the inner region A1, holes that enable water discharge are only the shower holes h1. Holes other than the shower holes h1 may be provided together with the shower holes h1 in the inner region A1. Preferably, as in this embodiment, holes that enable water discharge in the inner region A1 are only the shower holes h1.

A flow rate in a water passage facing the inner surface of the water discharge screen 114 is also referred to as a screen internal flow rate in the present application. A dynamic water pressure in a water passage facing the inner surface of the water discharge screen 114 is also referred to as a screen internal pressure in the present application. A flow velocity in a water passage facing the inner surface of the water discharge screen 114 is also referred to as a screen internal flow velocity in the present application.

When the screen internal pressure becomes high, the screen internal flow rate and the water discharge flow rate are increased. In this case, water discharged from a large number of the shower holes h1 forms a cleaning shower water shape. When the screen internal pressure becomes low, the screen internal flow rate and the water discharge flow rate are reduced. In this case, water discharged from a large number of the shower holes h1 forms a soft sprinkling water shape. The detail of the water shapes will be described later.

It is noted that water discharge holes may be disposed in the center part on the further inner side of the inner region A1 other than the shower holes. For the shape of water discharged from the water discharge holes other than the shower holes, spray and straight water shapes are shown, which are described in the Patent Document 1 (Japanese Examined Patent Application Publication No. 4-39386). In the case of this embodiment, a water passage communicating with the water discharge holes other than the shower holes is provided. It is noted that in the case where the water discharge holes other than the shower holes are provided in the center part on the inner side of the inner region A1, the structure of the watering nozzle 100 becomes complicated, and the watering nozzle 100 is apt to be increased in size. Therefore, from the viewpoint of downsizing and simplifying the structure of the watering nozzle 100, preferably, the water discharge holes other than the shower holes are not provided on the inner side of the inner region A1. Preferably, the inner region A1 includes the center of the water discharge screen 114, and forms the center region of the water discharge screen 114.

The outer circumferential region A2 is provided with a plurality of shower holes h2. In the outer circumferential region A2, the only holes that enable water discharge are the shower holes h2. Holes other than the shower holes h2 may be provided together with the shower holes h2 in the outer circumferential region A2. Preferably, as in this embodiment, the only holes that enable water discharge in the outer circumferential region A2 are the shower holes h2.

When the screen internal pressure becomes high, the screen internal flow rate and the water discharge flow rate are increased. In this case, water discharged from a large number of the shower holes h2 forms a shower water shape. When the screen internal pressure becomes low, the screen internal flow rate and the water discharge flow rate are reduced. In this case, water discharged from a large number of the shower holes h2 forms a sprinkling water shape. The detail of the water shapes will be described later.

### Definition of Terms

Here, from the viewpoint of clarity, terms in the present application are defined as below.

### Rotational Position R

As used herein, “rotational position R” means the relative position relationship between the outer casing 104 and the inner casing 106 in the circumferential direction. The rotational position R changes in stages and/or continuously. A change in stages and a continuous change may be combined together. Namely, the position may continuously change in a certain range, and the position may change in stages in the other region. It is noted that, preferably, the position continuously changes in the entire movable range, and this embodiment is an example of a continuous change. This continuous change is implemented by screw coupling, described later.

### Longitudinal Position P

As used herein, “longitudinal position P” means the relative position relationship between the outer casing 104 and the inner casing 106 in the longitudinal direction. The longitudinal position P changes in stages and/or continuously. A change in stages and a continuous change may be combined together. Namely, the position may continuously change in a certain range, and the position may change in stages in the other region. It is noted that, preferably, the position continuously changes in the entire movable range, and this embodiment is an example of a continuous change. The longitudinal position P changes continuously. The longitudinal position P is linked to the rotational position R. This linkage is implemented by screw coupling, described later.

### Shower Hole

The shower hole preferably has a hole diameter (the diameter of a hole) of 1.0 mm or less on the outer surface of the water discharge screen 114, or a hole having a hole area of 0.79 mm² or less on the outer surface of the water discharge screen 114. A more preferable hole diameter will be described later.

### Shower Water Discharge

As used herein, “shower water discharge” means water discharge from the shower holes. In the case where the screen internal flow rate is high, water discharged from a large number of the shower holes forms a shower water shape. In the case where the screen internal flow rate is low, water discharged from a large number of the shower holes forms a sprinkling water shape.

### Water Shape

The water shape is the shape of water discharge. The present application describes four water shapes. These four water shapes include a cleaning shower water shape, a soft sprinkling water shape, a sprinkling water shape, and a shower water shape. Any of these four water shapes are a water shape caused by shower water discharge.

### Cleaning Shower Water Shape and Soft Sprinkling Water Shape

Both of the cleaning shower water shape and the soft sprinkling water shape are the shape of water discharged from the inner region A1. There is no clear boundary between the cleaning shower water shape and the soft sprinkling water shape. In other words, the names of these water shapes are conceptual. The water shape can be continuously changed from the cleaning shower water shape to the soft sprinkling water shape depending on the screen internal flow rate. Shower water discharge where the watering range is relatively narrow and the power of water is strong is suited for the purpose of removing dirt with the power of water.

The cleaning shower water shape has a portion where water goes straight under gravity (a straight water discharge portion). In the straight water discharge portion, the water shape is a cone or a cylinder. In the soft sprinkling water shape, the straight water discharge portion is not provided or is very short.

### Sprinkling Water Shape and Shower Water Shape

Both of the sprinkling water shape and the shower water shape are the shape of water discharged from the outer circumferential region A2. There is no clear boundary between the sprinkling water shape and the shower water shape. In other words, the names of the water shapes are conceptual. The water shape can be continuously changed from the sprinkling water shape to the shower water shape depending on the screen internal flow rate.

The shower water shape has a portion where water goes straight under gravity (a straight water discharge portion). In the straight water discharge portion, the water shape is a cone. In the sprinkling water shape, the straight water discharge portion is not provided or very short.

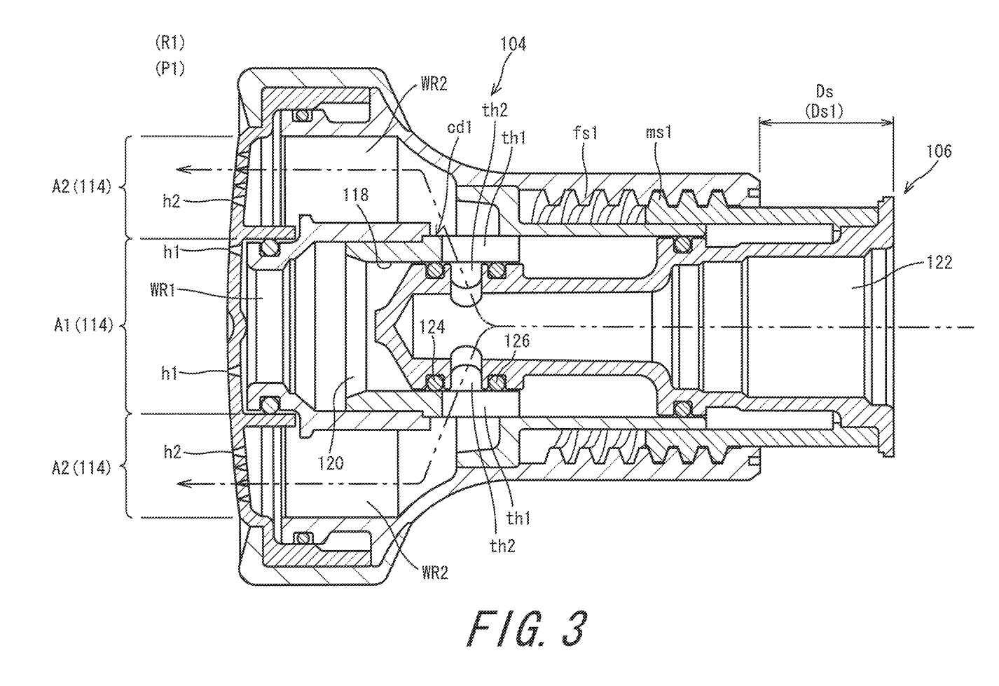

FIGS. 3 to 7 are cross sectional views of the outer casing 104 and the inner casing 106. In FIGS. 3 to 7, the outer casing 104 is rotated with respect to the inner casing 106 to change the rotational position R and the longitudinal position P. Thus, for example, a longitudinal distance Ds between the rear end of the inner casing 106 and the rear end of the outer casing 104 also continuously changes (see FIGS. 3 to 5). FIGS. 3 to 7 only show five examples among a large number of forms that are formed by a continuous change.

As illustrated in FIGS. 3 to 7, the outer casing 104 includes a first passage WR1 communicating with the inner region A1, a second passage WR2 communicating with the outer circumferential region A2, a female screw portion fs1, and a cylindrical member cd1. The cylindrical member cd1 includes a water communicating portion (a first water communicating portion) th1, a circumferential inner surface 118, and an inclined plane 120. The first water communicating portion th1 is a notch provided on the rear end portion of the cylindrical member cd1. The first water communicating portion th1 is provided at a plurality of locations on the cylindrical member cd1 in the circumferential direction. The first water communicating portion th1 may be a through hole. The inclined plane 120 has a conical concave where the inner diameter becomes greater further on the forward side.

As illustrated in FIGS. 3 to 7, the inner casing 106 includes a supply passage 122, a male screw portion ms1, and a water communicating portion (a second water communicating portion) th2. The second water communicating portion th2 is a hole penetrating through the inner casing 106. The second water communicating portion th2 is provided at a plurality of locations on the inner casing 106 in the circumferential direction. Moreover, the inner casing 106 includes a first water shut off portion 124 and a second water shut off portion 126.

The first water shut off portion 124 is provided on the forward side of the second water communicating portion th2. The second water shut off portion 126 is provided on the rear side of the second water communicating portion th2. The first water shut off portion 124 and the second water shut off portion 126 are an O-ring. The outer diameter of the first water shut off portion 124 is equal to the outer diameter of the second water shut off portion 126. The first water shut off portion 124 is disposed coaxially with the second water shut off portion 126. When the first water shut off portion 124 contacts with the circumferential inner surface 118, a watertight state is formed. When the second water shut off portion 126 contacts with the circumferential inner surface 118, a watertight state is formed. It is noted that a sealing member such as a hermetic sealing may be adopted instead of the O-ring.

The female screw portion fs1 and the male screw portion ms1 form screw coupling. As described above, when the outer casing 104 is rotated with respect to the inner casing 106, the rotational position R and the longitudinal position P continuously change due to this screw coupling.

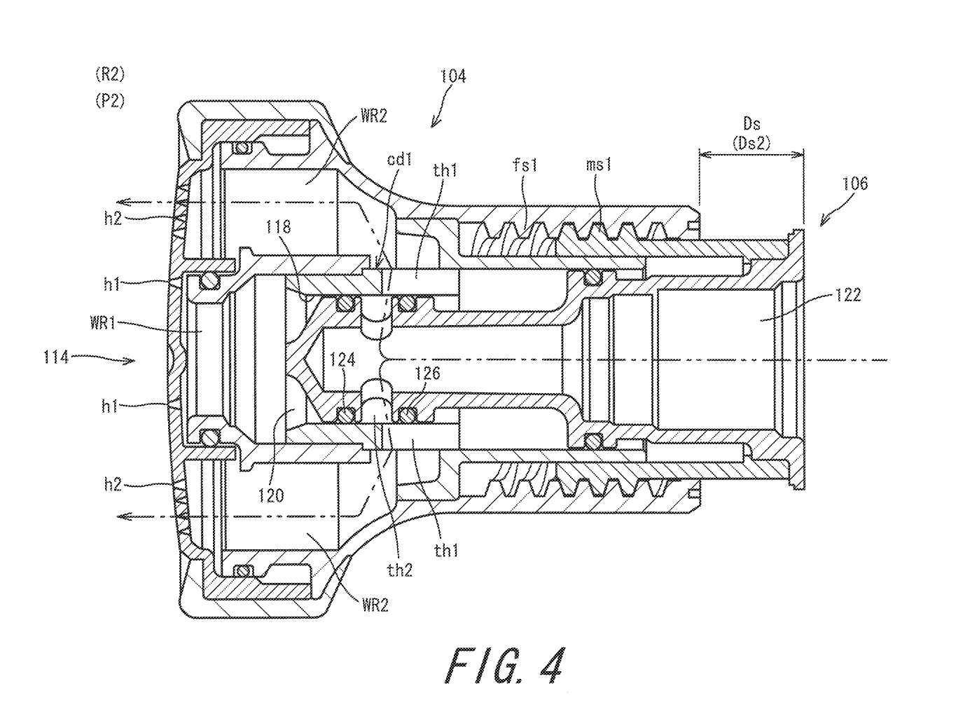

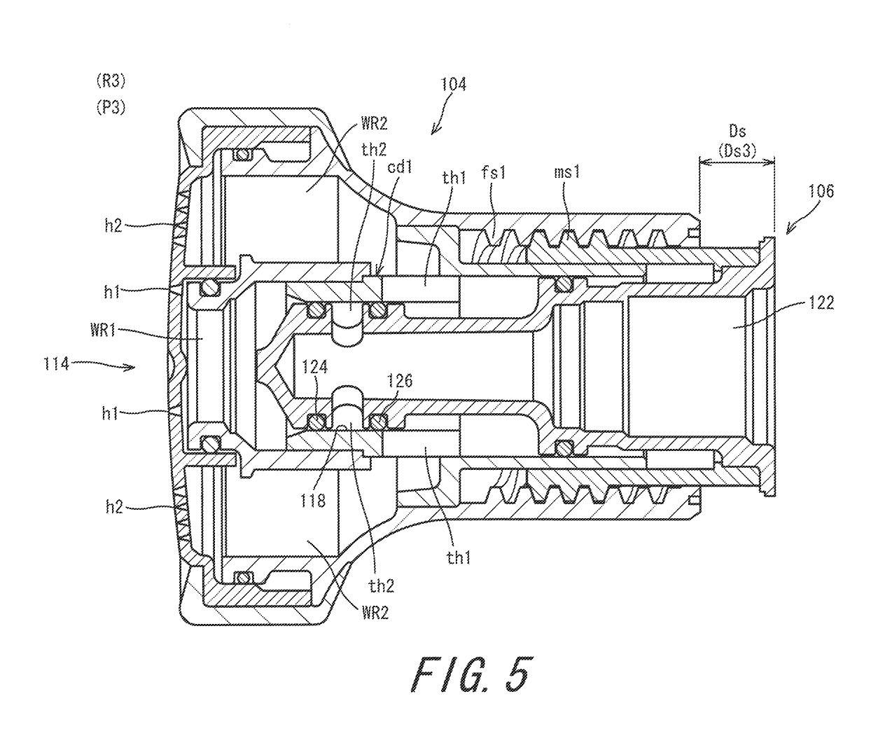

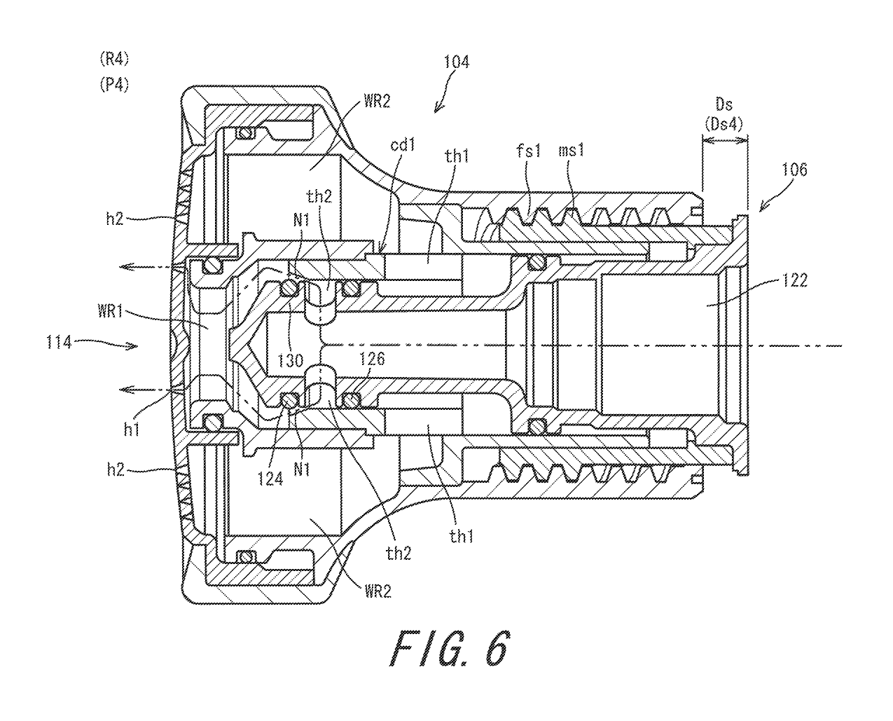

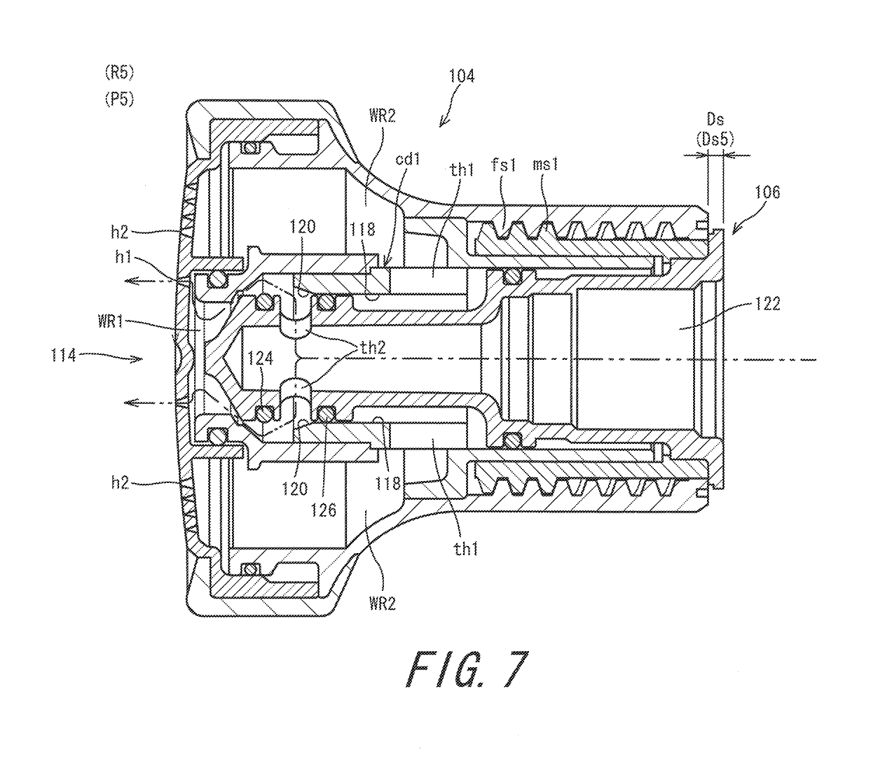

FIG. 3 is a cross sectional view where the rotational position R is located at a position R1. At this time, the longitudinal position P is located at a position P1, and the distance Ds is a distance Ds1. FIG. 4 is a cross sectional view where the rotational position R is located at a position R2. At this time, the longitudinal position P is located at a position P2, and the distance Ds is a distance Ds2. FIG. 5 is a cross sectional view where the rotational position R is located at a position R3. At this time, the longitudinal position P is located at a position P3, and the distance Ds is a distance Ds3. FIG. 6 is a cross sectional view where the rotational position R is located at a position R4. At this time, the longitudinal position P is located at a position P4, and the distance Ds is a distance Ds4. FIG. 7 is a cross sectional view where the rotational position R is located at a position R5. At this time, the longitudinal position P is located at a position P5, and the distance Ds is a distance Ds5. Where Ds1>Ds2>Ds3>Ds4>Ds5.

As described above, in the watering nozzle 100, the relative displacement enables selection between a state in which water in the supply passage 122 goes to the first passage WR1 and a state in which water in the supply passage 122 goes to the second passage WR2. This selection is alternative.

The following water shapes are represented by the forms in each respective figure.

FIG. 3 (positions P1 and R1): shower water shape

FIG. 4 (positions P2 and R2): sprinkling water shape

FIG. 5 (positions P3 and R3): water shut off state (no water discharge)

FIG. 6 (positions P4 and R4): soft sprinkling water shape

FIG. 7 (positions P5 and R5): cleaning shower water shape

In FIG. 6 (the positions P4 and R4) and FIG. 7 (the positions P5 and R5), water flows only through the first passage WR1. In FIG. 3 (the positions P1 and R1) and FIG. 4 (the positions P2 and R2), water flows only through the second passage WR2.

As described above, since the positions P and R change continuously, also in the forms not illustrated in FIGS. 3 to 7, the water discharge flow rate, the water discharge flow velocity, and the water shape can be obtained according to the positions P and R. The water discharge flow rate refers to the flow rate of water sprayed from the water discharge screen 114. The water discharge flow velocity refers to the water discharge flow velocity of water sprayed from the water discharge screen 114.

In FIGS. 3, 4, 6, and 7, the water flow is indicated by arrows of dashed double-dotted lines. It is noted that the water flow is not depicted in FIG. 5 because of the water shut off state.

In FIG. 3 (the positions P1 and R1), water supplied to the supply passage 122 is discharged from the shower holes h2 in the outer circumferential region A2 through the second water communicating portion th2, the first water communicating portion th1, and the second passage WR2. Since the first water shut off portion 124 contacts with the circumferential inner surface 118, water does not flow through the first passage WR1, and flows only through the second passage WR2. This water flow is the same in FIG. 4 (the positions P2 and R2). However, in the form in FIG. 4, the overlapping width of the first water communicating portion th1 with the second water communicating portion th2 is narrower than in the form in FIG. 3. Namely, in the form in FIG. 4, a passage cross sectional area (a boundary passage area Mk) is narrow in the boundary between the second water communicating portion th2 and the first water communicating portion th1. The screen internal pressure changes depending on the ratio between the boundary passage area Mk and a permeable area M2 (described later) in the outer circumferential region A2. Namely, when the ratio of Mk/M2 is large, the screen internal pressure is increased. In FIG. 3 (the positions P1 and R1), the ratio of Mk/M2 is relatively larger than in FIG. 4 (the positions P2 and R2). Thus, in FIG. 3 (the positions P1 and R1), the water discharge flow rate is larger and the water discharge flow velocity is faster than in FIG. 4 (the positions P2 and R2). The water shape is changed in association with the changes in the water discharge flow rate and the water discharge flow velocity. Of course, the water discharge flow rate and the water discharge flow velocity change continuously, and the water shape is also continuously changed between the positions P and R in FIG. 3 (the positions P1 and R1) and the positions P and R in FIG. 4 (the positions P2 and R2).

In FIG. 5 (the positions P3 and R3), the first water shut off portion 124 contacts with the circumferential inner surface 118, and the second water shut off portion 126 contacts with the circumferential inner surface 118. Therefore, water supplied to the supply passage 122 is shut off at the second water communicating portion th2. Water does not go to either the first passage WR1 or the second passage WR2, and water is shut off.

It is noted that the position to shut off water can be eliminated by changing dimensions. This is achieved in a case in which the longitudinal length of the circumferential inner surface 118 is made shorter than the longitudinal distance between the first water shut off portion 124 and the second water shut off portion 126, for example. In this case, the cylindrical member cd1 can be shortened, so that the watering nozzle 100 can be downsized.

In FIG. 6 (the positions P4 and R4), water supplied to the supply passage 122 is discharged from the shower holes h1 in the inner region A1 through the second water communicating portion th2 and the first passage WR1. Since the second water shut off portion 126 contacts with the circumferential inner surface 118, water does not flow through the second passage WR2, and flows only through the first passage WR1. This water flow is the same in FIG. 7 (the positions P5 and R5). However, in the form in FIG. 6, a narrow passage N1 is formed between a tip end portion 130 of the inner casing 106 or the first water shut off portion 124 and the inclined plane 120 (see FIG. 6). This passage N1 reduces the boundary passage area Mk, and the ratio of Mk/M1 that is the ratio of the boundary passage area Mk to a permeable area M1 is reduced in the inner region A1. The reduction in the ratio of Mk/M1 reduces the screen internal pressure in the first passage WR1. Therefore, the water discharge flow rate and the water discharge flow velocity are reduced. On the other hand, since the narrow passage N1 is eliminated in FIG. 7 (the positions P5 and R5), the ratio of Mk/M1 is increased more than in FIG. 6 (the positions P4 and R4). The increase in the ratio of Mk/M1 increases the water discharge flow rate and the water discharge flow velocity, and the water shape is changed. Of course, the water discharge flow rate and the water discharge flow velocity change continuously, and the water shape is also continuously changed in the positions P and R between FIG. 6 (the positions P4 and R4) and the positions P and R in FIG. 7 (the positions P5 and R5).

Originally, shower water discharge aims to spread fine water streams in a wide range. Thus, it is naturally considered that water is discharged from a wider region in shower water discharge, and it is not thought that shower water discharge is performed only from a narrow inner region A1. On the other hand, in the case where cleaning or the like is performed with a strong water stream, the straight water shape is used from the viewpoint of placing importance on strong water power. A technical idea that shower water is discharged from the inner region A1 is difficult to be conceived from a conventional technique level.

In recent years, a general watering nozzle is a watering nozzle that enables a large number of water shapes. A person skilled in the art implements watering nozzles of a high convenience with a diversity of water shapes. Thus, in conventional watering nozzles, selection is enabled between the straight water shape and the spray water shape in addition to the shower water shape. It is considered that a configuration in which the shape of water discharged from the inner region A1 is formed in the shower water shape goes against the diversity of water shapes, and is a configuration in the reverse direction of the technique level of a person skilled in the art.

The configuration of this embodiment overturns the technique level of a person skilled in the art described above. In FIG. 7 (the positions P5 and R5), strong shower water (a cleaning shower water shape) can be discharged from the inner region A1. In this shower water discharge, the following operation and effect can be obtained.

(a) A water discharge range is limited to a narrow region in the center part of the water discharge screen 114 (that is, in the inner region A1). Since strong shower water is discharged from a narrow range, strong shower water can be discharged in a narrow conical water shape in a narrow range.
(b) Dirt hardly removed can be washed off with a strong, local shower water discharge. Moreover, since a range in which water reaches is wider than in the straight water shape, the effect of removing dirt can be obtained in a wide range.
(c) Since the shape is a shower water shape and the water stream is narrow, a sharp water splash does not occur like the straight water shape although the water discharge flow velocity is high.
(d) The water discharge flow rate is smaller than in the conventional straight water shape although the water discharge flow velocity is high. Therefore, a high cleaning effect can be obtained while saving water.

On the other hand, in FIG. 6 (the positions P4 and R4), water discharged in a water shape where the water discharge flow rate is small (a soft sprinkling water shape) is made from only the inner region A1. A range in which water reaches is narrow, and a tiny water discharge flow rate is possible. Thus, this water shape is optimum for feeding water on flower pots and foliage plants, for example. Also the sprinkling water shape in FIG. 4 (the positions P2 and R2) enables a narrow range in which water reaches and a small water discharge flow rate. However, since water is discharged from a wide range (the outer circumferential region A2), the adjustment of a range in which water reaches and the water discharge flow rate has limitations as compared with the case of the soft sprinkling water shape. Therefore, it is sometimes difficult to feed water to a small flower pot and a small foliage plant, for example. Moreover, for the application of horticulture, it is sometimes desired to discharge water with small power in a small amount. However, it is difficult to make such water discharge in the sprinkling water shape. The soft sprinkling water shape in FIG. 6 (the positions P4 and R4) can solve this problem.

It is noted that the inclined plane 120 contributes to making the change rate of the water discharge flow rate or the water discharge flow velocity gentle with respect to the rotation angle of the rotational position R. Namely, the inclined plane 120 facilitates the adjustment of the water discharge flow rate and the water discharge flow velocity in the soft sprinkling water shape.

In the shower water shape in FIG. 3 (the positions P1 and R1), shower water is discharged from the outer circumferential region A2 in an annular shape (a donut shape). Therefore, such a water shape can be obtained wherein the water discharge flow rate is small and the diameter of a range in which water reaches is wide. The outer circumferential region A2 is provided on the outer side of the inner region A1 to reduce the area of the outer circumferential region A2 while increasing the diameter D2 of the outer circumferential region A2. The area is reduced to increase the diameter D2 while appropriately maintaining the layout density of the shower holes h2. Therefore, the area in which shower water discharge reaches can be increased with no excessive increase in the curvature of the spherical shape of the outer surface of the water discharge screen 114. In the case where the curvature of the spherical shape of the outer surface of the water discharge screen 114 is excessive, a water stream becomes unstable, and an appropriate shower water shape is not sometimes obtained.

In the watering nozzle 100, shower water discharge that continuously changes can be obtained from the inner region A1 as well as shower water discharge that continuously changes can be obtained from the outer circumferential region A2. Moreover, as described above, there are many differences between shower water discharged from the inner region A1 and shower water discharged from the outer circumferential region A2. As described above, in the watering nozzle 100, a variety of shower water discharge is implemented.

### Second Embodiment

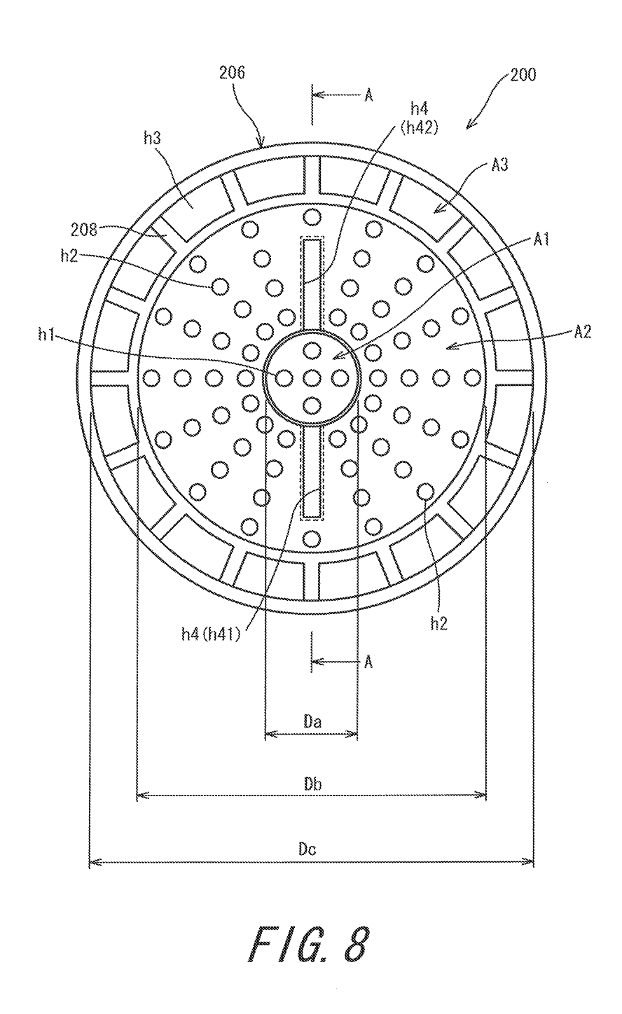

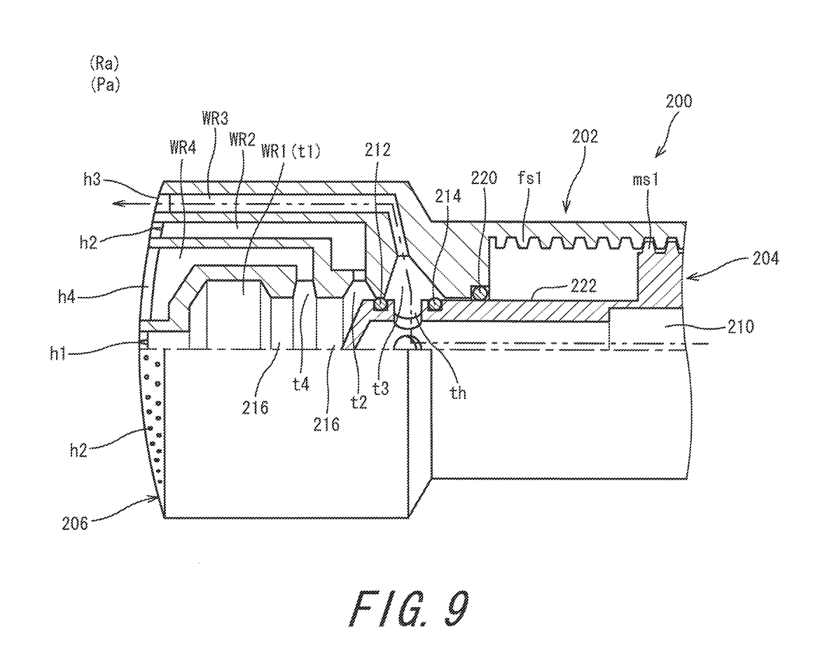

FIGS. 8 to 13 illustrate a watering nozzle 200 according to a second embodiment. FIG. 8 is a front view of the watering nozzle 200. FIGS. 9 to 13 are partially cutaway views of the watering nozzle 200. In FIGS. 9 to 13, the illustration of the main body of the watering nozzle 200 is omitted. FIGS. 9 to 13 are cross sectional views taken along line A-A in FIG. 8.

The watering nozzle 200 includes a main body, not illustrated, an outer casing 202, and an inner casing 204. The structure of the main body is similar to the structure of the watering nozzle 100 described above.

The outer casing 202 is rotatable with respect to the inner casing 204. This rotation changes rotational positions. A change in the rotational position changes the water shape. The detail of this point will be described later.

The outer casing 202 includes a water discharge screen 206. The water discharge screen 206 forms the front surface of the outer casing 202.

FIG. 8 is a plan view of the water discharge screen 206. The water discharge screen 206 includes an inner region A1, an outer circumferential region A2, and an outer edge region A3. The inner region A1 is a circular region where the diameter is a diameter Da when seen in a plane (FIG. 8). The outer circumferential region A2 is an annular region. The outer circumferential region A2 is located on the outer side of the inner region A1 (on the outer side in the radial direction). In FIG. 8, the outer diameter of the outer circumferential region A2 is denoted by reference character Db. The diameter Db is the diameter when seen in a plane. The outer edge region A3 is an annular region. The outer edge region A3 is located on the outer side of the outer circumferential region A2 (on the outer side in the radial direction). In FIG. 8, the outer diameter of the outer edge region A3 is denoted by reference character Dc. The diameter Dc is the diameter when seen in a plane. As illustrated in FIGS. 9 to 13 described later, the outer surface of the water discharge screen 206 forms a convex curved surface. The convex curved surface has a spherical shape. The convex curved surface increases a range in which water reaches.

Preferably, the inner region A1 has a circular shape. However, the inner region A1 may have other shapes, an ellipse or a rectangle, for example. Lmax and Lmin are defined as described above. In the case where the outer edge of the inner region A1 has a non-circular shape, preferably, the ratio of Lmax/Lmin is equal to or less than 2, more preferably, equal to or less than 1.5, and much more preferably, equal to or less than 1.2. In the inner region A1 in a circular shape, the ratio of Lmax/Lmin is 1.

Preferably, the shape of the inner edge of the outer circumferential region A2 is the same as the shape of the outer edge of the inner region A1 as described above. In this case, more preferably, the inner edge of the outer circumferential region A2 is matched with the outer edge of the inner region A1. Preferably, the outer edge of the outer circumferential region A2 has a circular shape. However, the outer circumferential region A2 may have other shapes, an ellipse or a rectangle, for example. Mmax and Mmin are defined as described above. In the case where the outer edge of the outer circumferential region A2 has a non-circular shape, preferably, the ratio of Mmax/Mmin is equal to or less than 2, more preferably, equal to or less than 1.5, and much more preferably, equal to or less than 1.2. In the outer circumferential region A2 having the outer edge in a circular shape, the ratio of Mmax/Mmin is 1.

The inner region A1 is provided with a plurality of shower holes h1. In the inner region A1, holes that enable water discharge are only the shower holes h1. Holes other than the shower holes h1 may be provided together with the shower holes h1 in the inner region A1. Preferably, as in this embodiment, holes that enable water discharge in the inner region A1 are only the shower holes h1.

In the case where the screen internal pressure is high, water discharged from a large number of the shower holes h1 forms a cleaning shower water shape. In the case where the screen internal pressure is low, water discharged from a large number of the shower holes h1 forms a soft sprinkling water shape.

The outer circumferential region A2 is provided with a plurality of shower holes h2. In the outer circumferential region A2, holes that enable water discharge are the shower holes h2 and a straight hole h4 (described later). Holes other than the shower holes h2 and the straight hole h4 may be provided together with the shower holes h2 and a straight hole h4 in the outer circumferential region A2. Preferably, as in this embodiment, holes that enable water discharge in the outer circumferential region A2 are limited to the shower holes h2 and the straight hole h4.

In the case where the screen internal pressure is high, water discharged from a large number of the shower holes h2 forms a shower water shape. In the case where the screen internal pressure is low, water discharged from a large number of the shower holes h2 forms a sprinkling water shape.

Moreover, the straight hole h4 is provided in the outer circumferential region A2. The straight hole h4 is provided along a single straight line when seen in a plane (FIG. 8). The straight hole h4 is not provided in the inner region A1. The straight hole h4 includes a first straight hole h41 and a second straight hole h42. The straight hole h41 and the straight hole h42 are a long hole. The straight hole h41 and the straight hole h42 are provided along the same straight line.

In the outer circumferential region A2, the only holes that enable water discharge are the shower holes h2 and the straight hole h4.

In the case where the screen internal pressure is high, the straight hole h4 forms a fan-shaped water shape.

An annular opening h3 is provided in the outer edge region A3. A plurality of partitions 208 is provided in the annular opening h3. The partitions 208 are provided at regular intervals in the circumferential direction. A wide opening area is secured in the annular opening h3 as a whole. In water discharged from the annular opening h3, the water discharge flow rate is large. The annular opening h3 can secure a sufficient water discharge flow rate.

As illustrated in FIGS. 9 to 13, the outer casing 202 is rotated with respect to the inner casing 204 to change the rotational position R and the longitudinal position P. As similar to the watering nozzle 100 described above, the rotational position R changes continuously, and the longitudinal position P also changes continuously. FIGS. 9 to 13 show only five examples among a large number of forms that are formed by a continuous change.

As illustrated in FIGS. 9 to 13, the outer casing 202 includes a first passage WR1 communicating with the inner region A1, a second passage WR2 communicating with the shower holes h2 in the outer circumferential region A2, a third passage WR3 communicating with the outer edge region A3, and a fourth passage WR4 communicating with the straight hole h4. The outer casing 202 further includes a female screw portion fs1, a first conduit portion t1, a second conduit portion t2, a third conduit portion t3, and a fourth conduit portion t4.

The first conduit portion t1 is a part of the first passage WR1. The second conduit portion t2 communicates with the second passage WR2. The third conduit portion t3 communicates with the third passage WR3. The fourth conduit portion t4 communicates with the fourth passage WR4.

As illustrated in FIGS. 9 to 13, the inner casing 204 includes a supply passage 210, a male screw portion ms1, and a water communicating portion th. The water communicating portion th is a hole penetrating through the inner casing 204. The water communicating portion th is provided at a plurality of locations on the inner casing 204 in the circumferential direction. Moreover, the inner casing 204 includes a first water shut off portion 212 and a second water shut off portion 214.

The first water shut off portion 212 is provided on the forward side of the water communicating portion th. The second water shut off portion 214 is provided on the rear side of the water communicating portion th. The first water shut off portion 212 and the second water shut off portion 214 are an O-ring. The outer diameter of the first water shut off portion 212 is equal to the outer diameter of the second water shut off portion 214. The first water shut off portion 212 is disposed coaxially with the second water shut off portion 214. When the first water shut off portion 212 contacts with a circumferential inner surface 216, a watertight state is formed. Similarly, when the second water shut off portion 214 contacts with the circumferential inner surface 216, a watertight state is formed.

The female screw portion fs1 and the male screw portion ms1 form a screw coupling. As described above, when the outer casing 202 is rotated with respect to the inner casing 204, the rotational position R and the longitudinal position P continuously change due to this screw coupling.

It is noted that a change in the rotational position R is not limited to a continuous change. The rotational position R changes in stages and/or continuously. A change in stages and a continuous change may be combined together. Namely, the position R may continuously change in a certain range, and the position R may change in stages in the other region. It is noted that preferably, the position R continuously changes in the entire movable range, and this embodiment is an example of a continuous change.

A change in the longitudinal position P is not limited to a continuous change. The longitudinal position P changes in stages and/or continuously. A change in stages and a continuous change may be combined together. Namely, the position P may continuously change in a certain range, and the position P may change in stages in the other region. It is noted that, preferably, the position P continuously changes in the entire movable range, and this embodiment is an example of a continuous change.

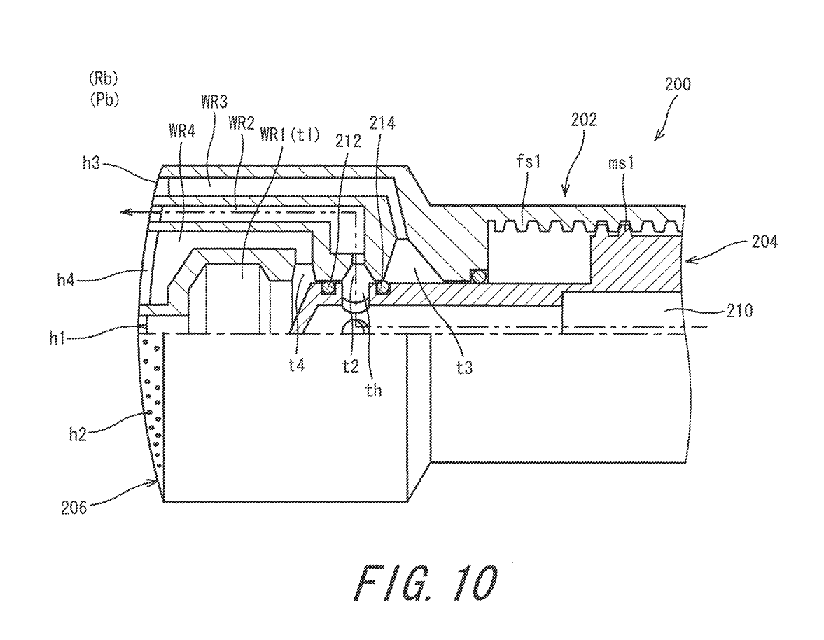

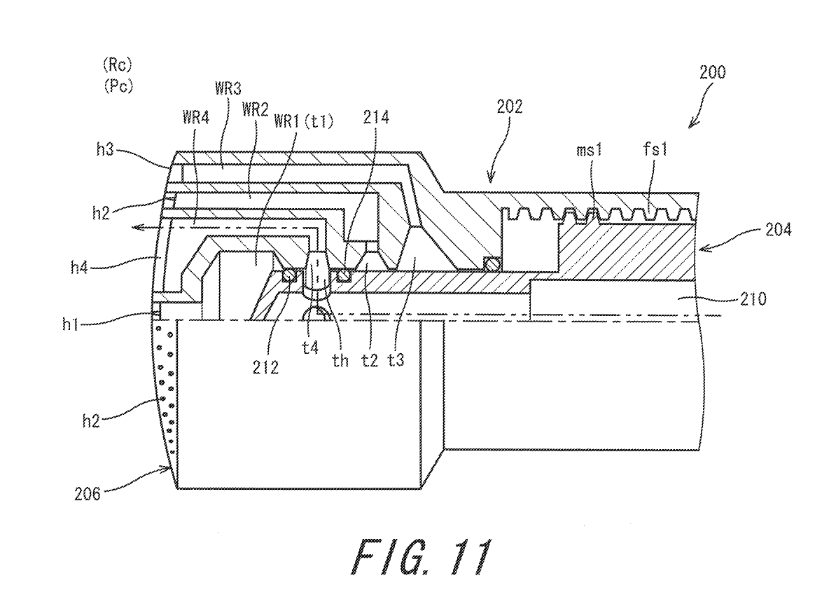

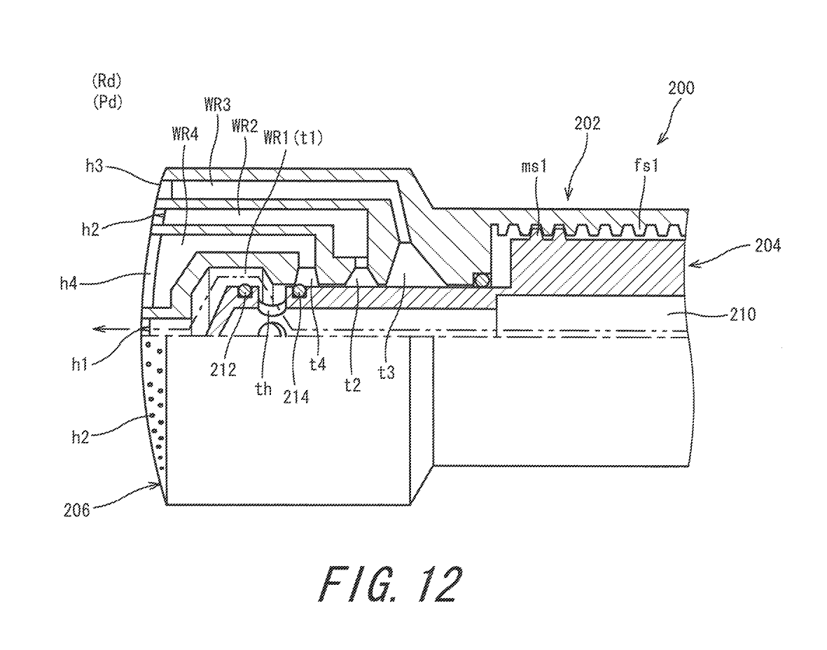

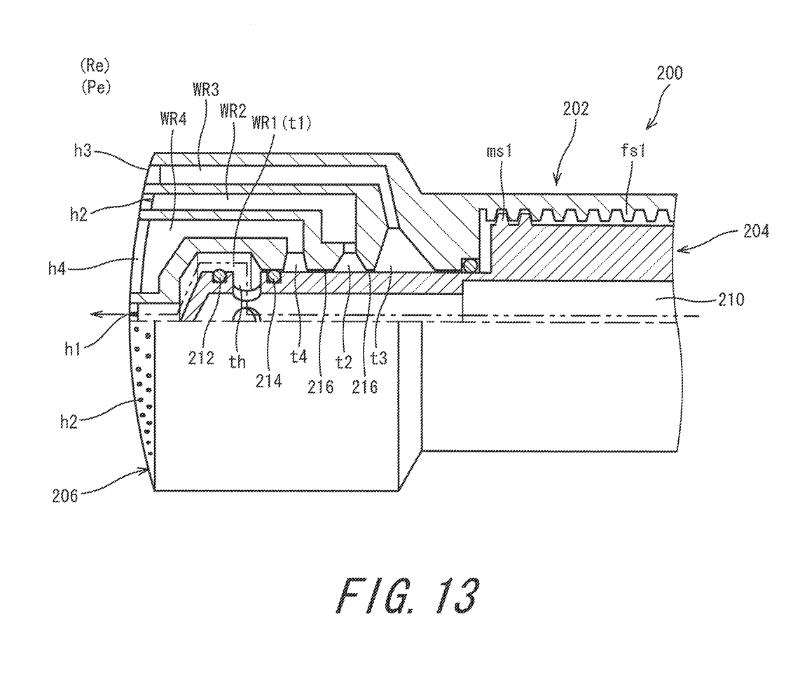

FIG. 9 is a cross sectional view where the rotational position R is located at a position Ra. At this time, the longitudinal position P is located at a position Pa. FIG. 10 is a cross sectional view where the rotational position R is located at a position Rb. At this time, the longitudinal position P is located at a position Pb. FIG. 11 is a cross sectional view where the rotational position R is located at a position Rc. At this time, the longitudinal position P is located at a position Pc. FIG. 12 is a cross sectional view where the rotational position R is located at a position Rd. At this time, the longitudinal position P is located at a position Pd. FIG. 13 is a cross sectional view where the rotational position R is located at a position Re. At this time, the longitudinal position P is located at a position Pe.

The following water shapes are represented by the forms in each respective figure.

FIG. 9 (positions Pa and Ra): open water shape

FIG. 10 (positions Pb and Rb): shower water shape (and the sprinkling water shape)

FIG. 11 (positions Pc and Rc): fan-shaped water shape

FIG. 12 (positions Pd and Rd): soft sprinkling water shape

FIG. 13 (positions Pe and Re): cleaning shower water shape

As described above, since the positions P and R change continuously, water shapes can be obtained according to the positions P and R also in the forms not illustrated in FIGS. 9 to 13.

In FIGS. 9 to 13, the water flow is indicated by arrows of dashed double-dotted lines.

In FIG. 9 (the positions Pa and Ra), the position of the water communicating portion th in the longitudinal direction overlaps with the third conduit portion t3. At the positions Pa and Ra, water supplied to the supply passage 210 is discharged from the annular opening h3 in the outer edge region A3 through the water communicating portion th, the third conduit portion t3, and the third passage WR3. The first water shut off portion 212 contacts with the circumferential inner surface 216 to prevent water leakage to the forward side. Moreover, a third water shut off portion 220 contacts with a circumferential outer surface 222 of the inner casing 204 to prevent water leakage to the rear side. Therefore, water flows only through the third passage WR3. Furthermore, the relative position relationship between the water communicating portion th and the third conduit portion t3 changes the passage width (the cross sectional area) in the boundary portion between the water communicating portion th and the third conduit portion t3. This change can continuously adjust the water discharge flow rate and the water discharge flow velocity.

In the present application, water discharged from the annular opening h3 is referred to as an open water shape. In the open water shape implemented at the positions Pa and Ra, a large water discharge flow rate is secured. Moreover, the water discharge flow velocity is low, and a water splash is suppressed. The open water shape is convenient in the case where a large amount of water is supplied for a short time.

In FIG. 10 (the positions Pb and Rb), the position of the water communicating portion th in the longitudinal direction overlaps with the second conduit portion t2. At the positions Pb and Rb, water supplied to the supply passage 210 is discharged from the shower holes h2 in the outer circumferential region A2 through the water communicating portion th, the second conduit portion t2, and the second passage WR2. The first water shut off portion 212 contacts with the circumferential inner surface 216 to prevent water leakage to the forward side. Similarly, the second water shut off portion 214 contacts with the circumferential inner surface 216 to prevent water leakage to the rear side. Therefore, water flows only through the second passage WR2. Moreover, the relative position relationship between the water communicating portion th and the second conduit portion t2 changes the passage width (the cross sectional area) in the boundary portion between the water communicating portion th and the second conduit portion t2. This change can continuously adjust the water discharge flow rate and the water discharge flow velocity. This adjustment enables a continuous change from the shower water shape to the sprinkling water shape.

It is noted that the second passage WR2 communicates with all of the shower holes h2, although not illustrated in FIG. 10, which is caused by the position in the cross section.

In FIG. 11 (the positions Pc and Rc), the position of the water communicating portion th in the longitudinal direction overlaps with the fourth conduit portion t4. At the positions Pc and Rc, water supplied to the supply passage 210 is discharged from the straight hole h4 through the water communicating portion th, the fourth conduit portion t4, and the fourth passage WR4. The first water shut off portion 212 contacts with the circumferential inner surface 216 to prevent water leakage to the forward side. Similarly, the second water shut off portion 214 contacts with the circumferential inner surface 216 to prevent water leakage to the rear side. Therefore, water flows only through the fourth passage WR4. Moreover, the relative position relationship between the water communicating portion th and the fourth conduit portion t4 changes the passage width (the cross sectional area) in the boundary portion between the water communicating portion th and the fourth conduit portion t4. This change can continuously adjust the water discharge flow rate and the water discharge flow velocity. This adjustment enables a continuous change in the fan-shaped water shape.

It is noted that in the fan-shaped water shape, watering is enabled in a wider region. Therefore, in the case where a wide area in which water reaches is secured, the fan-shaped water shape is convenient.

In FIG. 12 (the positions Pd and Rd), the position of the water communicating portion th in the longitudinal direction overlaps with the first conduit portion t1 (the first passage WR1). At the positions Pd and Rd, water supplied to the supply passage 210 is discharged from the shower holes h1 through the water communicating portion th, the first conduit portion t1, and the first passage WR1. The second water shut off portion 214 contacts with the circumferential inner surface 216 to prevent water leakage to the rear side. Therefore, water flows only through the first passage WR1.

In FIG. 13 (the positions Pe and Re), the path of the water flow is the same as in FIG. 12 (the positions Pd and Rd). However, in FIG. 13 (the positions Pe and Re), the overlapping width of the first conduit portion t1 (the first passage WR1) with the water communicating portion th is larger than in FIG. 12 (the positions Pd and Rd). Therefore, the passage width (the cross sectional area) in the boundary portion between the water communicating portion th and the first conduit portion t1 is wide. Thus, a large water discharge flow rate and a fast water discharge flow velocity are implemented. On the contrary, in FIG. 12 (the positions Pd and Rd), the passage width (the cross sectional area) in the boundary portion between the water communicating portion th and the first conduit portion t1 is relatively narrow. Therefore, a cleaning shower water shape is formed in FIG. 13 (the positions Pe and Re), whereas a soft sprinkling water shape is formed in FIG. 12 (the positions Pd and Rd). Of course, a continuous change in water shapes including the cleaning shower water shape and the soft sprinkling water shape is possible.

As described above, in the watering nozzle 200 according to the second embodiment, in addition to the effect obtained by the watering nozzle 100 according to the foregoing first embodiment, the open water shape and the fan-shaped water shape are implemented. Although these water shapes are additionally provided, the function achieved in the foregoing watering nozzle 100 is maintained. Therefore, the watering nozzle of a higher convenience is implemented. Particularly in the watering nozzle 200, no straight hole h4 is provided in the inner region A1. Namely, only shower holes are provided in the inner region A1. Therefore, the effect achieved by shower water discharged from the inner region A1 is also achieved in the watering nozzle 200.

The forms, configurations, and the like described in the first embodiment and/or the second embodiment are individually applicable to the entire inventions described in the present application including inventions described in the appended claims of the present application without including all of the forms or configurations of the embodiments.

### Hole Diameter of the Shower Holes h1 in the Inner Region A1 or the Like

From the viewpoint of increasing the water discharge flow velocity of shower water discharged from the inner region A1 and from the viewpoint of suppressing a water splash, preferably, the hole diameter of the shower hole h1 is equal to or less than 0.46 mm, and more preferably, equal to or less than 0.38 mm. From the viewpoint of preventing the water discharge flow rate from being too small, preferably, the hole diameter of the shower hole h1 is equal to or greater than 0.34 mm, and more preferably, equal to or greater than 0.38 mm. In examples described later, the hole diameter of the shower hole h1 was 0.38 mm.

The shower holes h1 with different hole diameters may be combined together. In the case of the combination, preferably, the mean value of the hole diameters of all the shower holes h1 satisfies the limitations of the numeric values described above, and more preferably, the hole diameters of all the shower holes h1 satisfy the limitations of the numeric values described above.

Preferably, the shower hole h1 has a circular shape. However, the shower hole h1 may have other shapes, an ellipse or a rectangle, for example. Moreover, the shower hole h1 in a circular shape and one type or greater of the shower hole h1 in a non-circular shape may be combined together. The shower holes h1 in a circular shape and two types or greater of the shower holes h1 in a non-circular shape may be combined together. In the foregoing embodiments, all the shower holes h1 have a circular shape.

In the case where the shower hole h1 in a non-circular shape is adopted, preferably, the outer edge of the shower hole h1 has a shape with no inward recess, an ellipse or a regular polygon, for example. Here, suppose that a distance between two points on the outer edge of the shower hole h1 is a clearance G. The clearance G is the length of a line segment having the two points at both ends and passing through the center of the outer edge. The maximum value of the clearance G is Gmax, and the minimum value of the clearance G is Gmin. In the case where the outer edge of the shower hole h1 has a non-circular shape, preferably, the ratio of Gmax/Gmin is equal to or less than 2, more preferably, equal to or less than 1.5, and much more preferably, equal to or less than 1.2. In the shower hole h1 in a circular shape, the ratio of Gmax/Gmin is 1.

In the case where the shower hole h1 in a non-circular shape is adopted, a diameter Dh of a circular hole having the same area as the area of the hole in the non-circular shape is calculated. From the viewpoint of increasing the water discharge flow velocity of shower water discharged from the inner region A1 and from the viewpoint of suppressing a water splash, preferably, this diameter Dh is equal to or less than 0.46 mm, and more preferably, equal to or less than 0.38 mm. From the viewpoint of preventing the water discharge flow rate from being too small, preferably, the diameter Dh is equal to or greater than 0.34 mm, and more preferably, equal to or greater than 0.38 mm.

### Number of the Shower Holes h1 in the Inner Region A1

From the viewpoint of suppressing a water splash in shower water discharged from the inner region A1, preferably, the number of the shower holes h1 is equal to or greater than 68. From the viewpoint of the water discharge flow velocity and saving water, preferably, the number of the shower holes h1 is equal to or less than 100, and more preferably, equal to or less than 68. In examples described later, the number of shower holes h1 was 68.

### Permeable Area M1 in the Inner Region A1

From the viewpoint of preventing the water discharge flow rate from being too small, preferably, the permeable area M1 in the inner region A1 is equal to or greater than 7.7 mm². From the viewpoint of increasing the water discharge flow velocity, preferably, the permeable area M1 in the inner region A1 is equal to or less than 11 mm², and more preferably, equal to or less than 7.7 mm². In examples described later, the permeable area M1 was 7.7 mm². The permeable area M1 is the sum total of the hole areas of all the water through holes in the inner region A1. The hole area is the area on the outer surface of the water discharge screen.

### Hole Diameter of the Shower Holes h2 in the Outer Circumferential Region A2

From the viewpoint of the water discharge flow velocity, preferably, the hole diameter of the shower hole h2 is equal to or less than 0.36 mm, and more preferably, equal to or less than 0.28 mm. From the viewpoint of preventing the water discharge flow rate from being too small, preferably, the hole diameter of the shower hole h2 is equal to or greater than 0.24 mm, and more preferably, equal to or greater than 0.28 mm. In examples described later, the hole diameter of the shower hole h2 was 0.28 mm.

The shower holes h2 with different hole diameters may be combined together. In the case of the combination, preferably, the mean value of the hole diameters of all the shower holes h2 satisfies the limitations of the numeric values described above, and more preferably, the hole diameters of all the shower holes h2 satisfy the limitations of the numeric values described above.

Preferably, the shower hole h2 has a circular shape. However, the shower hole h2 may have other shapes, an ellipse or a rectangle, for example. Moreover, the shower hole h2 of a circular shape and one type or greater of the shower hole h2 of a non-circular shape may be combined together. The shower hole h2 of a circular shape and two types or greater of the shower holes h2 in non-circular shapes may be combined together. In the foregoing embodiments, all the shower holes h2 have a circular shape.

In the case where the shower hole h2 of a non-circular shape is adopted, preferably, the outer edge of the shower hole h2 has a shape with no inward recess, an ellipse, or a regular polygon, for example. Here, suppose that a distance between two points on the outer edge of the shower hole h2 is a clearance H. The clearance H is the length of a line segment having the two points at both ends and passing through the center of the outer edge. The maximum value of the clearance H is Hmax, and the minimum value of the clearance H is Hmin. In the case where the outer edge of the shower hole h2 has a non-circular shape, preferably, the ratio of Hmax/Hmin is equal to or less than 2, more preferably, equal to or less than 1.5, and much more preferably, equal to or less than 1.2. In the shower hole h2 of a circular shape, the ratio of Hmax/Hmin is 1.

In the case where the shower hole h2 of a non-circular shape is adopted, a diameter Dj of a circular hole having the same area as the area of the hole in the non-circular shape is calculated. From the viewpoint of increasing the water discharge flow velocity of shower water discharged from the outer circumferential region A2 and from the viewpoint of suppressing a water splash, preferably, this diameter Dj is equal to or less than 0.46 mm, and more preferably, equal to or less than 0.38 mm. From the viewpoint of preventing the water discharge flow rate from being too small, preferably, the diameter Dj is equal to or greater than 0.34 mm, and more preferably, equal to or greater than 0.38 mm.

### Number of the Shower Holes h2 in the Outer Circumferential Region A2

From the viewpoint of obtaining an appropriate water discharge flow rate and an appropriate water discharge flow velocity, preferably, the number of the shower holes h2 is equal to or greater than 220, and more preferably, equal to or greater than 250. From the viewpoint of the water discharge flow velocity and saving water, preferably, the number of the shower holes h2 is equal to or less than 258. In examples described later, the number of the shower holes h2 was 258.

### Permeable Area M2 in the Outer Circumferential Region A2

From the viewpoint of preventing the water discharge flow rate from being too small, preferably, the permeable area M2 in the outer circumferential region A2 is equal to or greater than 15.0 mm², and more preferably, equal to or greater than 15.9 mm². From the viewpoint of obtaining an appropriate water discharge flow velocity, preferably, the permeable area M2 in the outer circumferential region A2 is equal to or less than 15.9 mm². In examples described later, the permeable area was 15.9 mm². The permeable area M2 is the sum total of the hole areas of all the water through holes in the outer circumferential region A2. The hole area is the area on the outer surface of the water discharge screen.

### Spread Shape of Shower Water Discharge

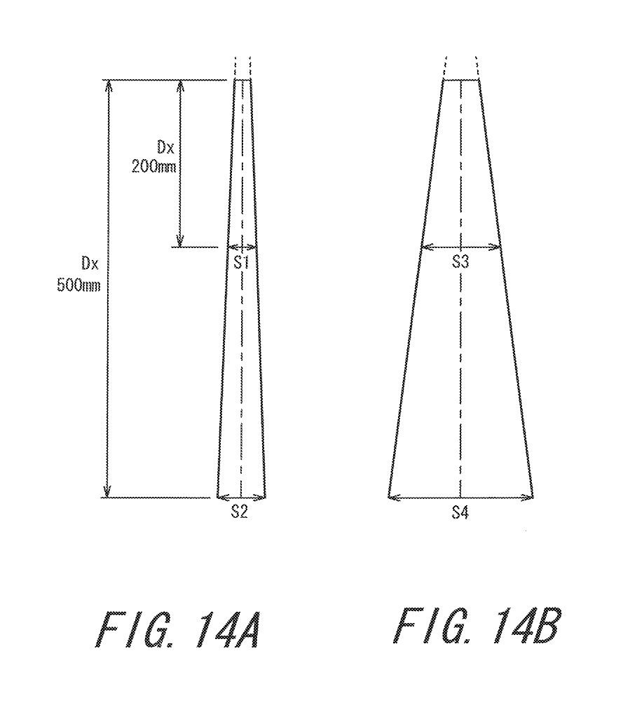

As illustrated in FIGS. 14A and 14B, described later, the water shape width can be measured when seen from above in water discharged in the horizontal direction. In water discharged in the horizontal direction, a state (a forward water discharge state) is set, in which the straightness of water discharge can be maintained. For example, the tap water pressure in the case where there is the forward water discharge state from the water discharge screen to a location where the distance therebetween is 500 mm is equal to or greater than 0.3 MPa. In the forward water discharge state, the water shape width at a location where the horizontal distance is 200 mm is S1 or S3, and the water shape width at a location where the horizontal distance is 500 mm is S2 or S4.

### Water Shape Width S1 in water discharged from the Inner Region A1 (at a Location where the Distance is 200 mm)

From the viewpoint of suppressing a water splash and from the viewpoint of a range in which water reaches, preferably, the water shape width S1 in shower water discharged from the inner region A1 is equal to or greater than 30 mm. From the viewpoint of enhancing the cleaning effect, preferably, the water shape width S1 in shower water discharged from the inner region A1 is equal to or less than 40 mm. In examples described later, in the forward water discharge state, the water shape width S1 was 33 mm.

### Water Shape Width S2 in water discharged from the Inner Region A1 (at a Location where the Distance is 500 mm)

From the viewpoint of suppressing a water splash and from the viewpoint of a range in which water reaches, preferably, the water shape width S2 in shower water discharged from the inner region A1 is equal to or greater than 47 mm. From the viewpoint of enhancing the cleaning effect, preferably, the water shape width S2 in shower water discharged from the inner region A1 is equal to or less than 57 mm. In examples described later, in the forward water discharge state, the water shape width S2 was 52 mm.

### Water Shape Width S3 in water discharged from the Outer Circumferential Region A2 (at a Location where the Distance is 200 mm)

From the viewpoint of securing a range in which water reaches, preferably, the water shape width S3 in shower water discharged from the outer circumferential region A2 is equal to or greater than 88 mm. From the viewpoint of preventing an excessive spread water shape, preferably, the water shape width S3 in shower water discharged from the outer circumferential region A2 is equal to or less than 98 mm. In examples described later, in the forward water discharge state, the water shape width S3 was 93 mm.

### Water Shape Width S4 in water discharged from the Outer Circumferential Region A2 (at a Location where the Distance is 500 mm)

From the viewpoint of securing a range in which water reaches, preferably, the water shape width S4 in shower water discharged from the outer circumferential region A2 is equal to or greater than 161 mm. From the viewpoint of preventing an excessive spread water shape, preferably, the water shape width S4 in shower water discharged from the outer circumferential region A2 is equal to or less than 171 mm. In examples described later, in the forward water discharge state, the water shape width S4 was 166 mm.

As illustrated in FIGS. 14A and 14B, at locations where a distance which water goes is 200 mm and 500 mm, a range in which the water discharged from the inner region reaches is narrower than a range in which the water discharged from the outer circumferential region reaches. Moreover, in the embodiments, a range in which the water discharged from the inner region reaches is narrower than a range in which the water discharged from the outer circumferential region reaches, regardless of a distance which the water goes. The range in which the water reaches is determined in the forward water discharge state.

A material of the water discharge screen 114 includes a POM (polyacetal) resin, and an ABS resin. From the viewpoint of chemical resistance and light resistance, a POM (polyacetal) resin is preferable. In examples described later, a POM (polyacetal) resin was used.

For a material of the outer casing 104, an ABS resin is preferable from the viewpoint of the fixity of printing, adhesion strength, and appearance. In examples described later, an ABS resin was used.

For a material of the cylindrical member cd1, an ABS resin is preferable from the viewpoint of adhesion strength. In examples described later, an ABS resin was used.

For a material of the inner casing 106, an ABS resin is preferable from the viewpoint of adhesion strength and appearance. In examples described later, an ABS resin was used.

### EXAMPLES

In the following, the effect of the present invention will be apparent from examples. However, the present invention should not be interpreted in a limited way based on the description of the examples.

### Examples

The watering nozzle 100 according to the first embodiment was used to conduct tests on the water shape, the water discharge flow rate, and the water discharge flow velocity.

For the rotational position R, “shower,” “sprinkling,” “soft sprinkling,” and “cleaning shower” were selected. “Shower” was the state illustrated in FIG. 3 (the positions P1 and R1). “Sprinkling” was the state illustrated in FIG. 4 (the positions P2 and R2). “Soft sprinkling” was the state illustrated in FIG. 6 (the positions P4 and R4). “Cleaning shower” was the state illustrated in FIG. 7 (the positions P5 and R5).

FIG. 14A is a diagram of the water shape (contour) of “cleaning shower” of water discharged in the horizontal direction when seen from above. FIG. 14B is a diagram of the water shape (contour) of “shower” of water discharged in the horizontal direction when seen from above. As described above, in the measured result, the water shape width S1 was 33 mm, the water shape width S2 was 52 mm, the water shape width S3 was 93 mm, and the water shape width S4 was 166 mm. As described above, a variety of shower water discharge was enabled. Moreover, the water shape of “cleaning shower” with a high convenience was implemented in the application of cleaning or the like.

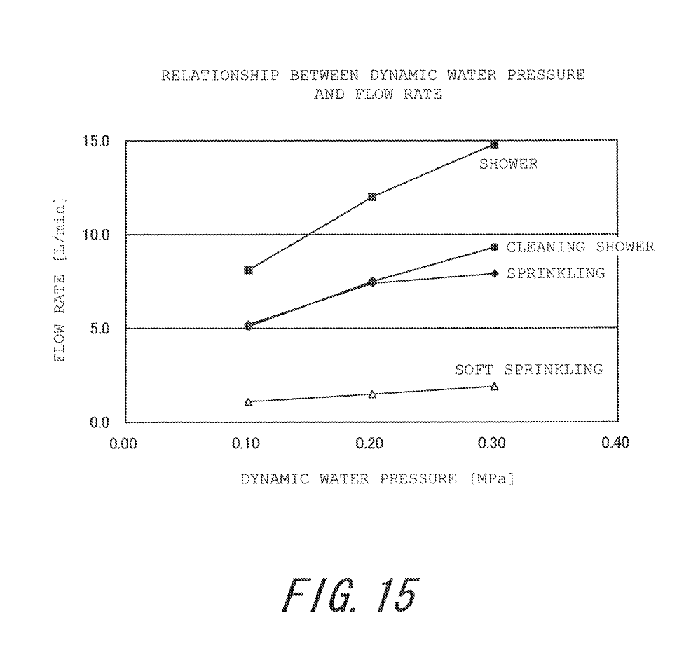

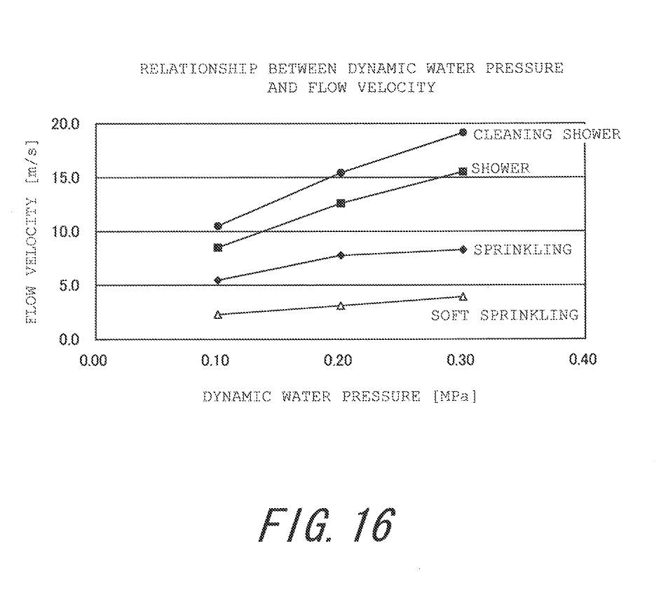

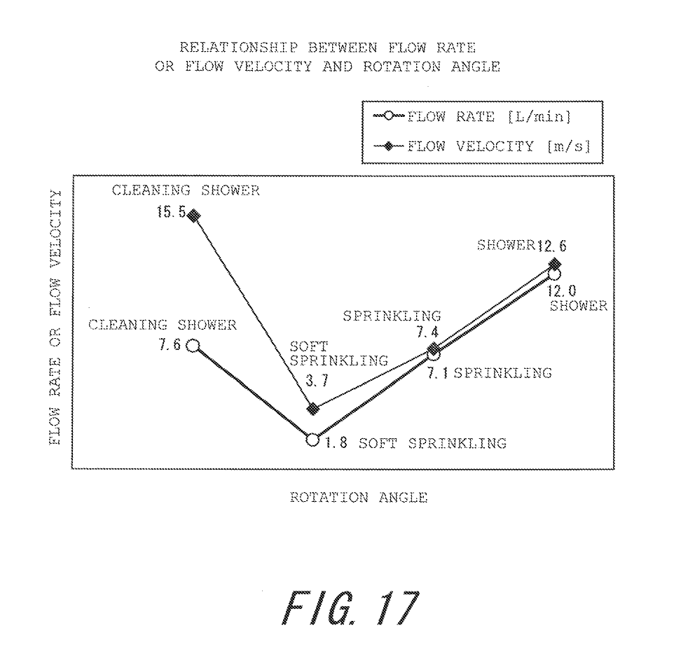

FIG. 15 is a graph of the relationship between the tap water pressure (MPa) and the water discharge flow rate (L/min) at four rotational positions R. FIG. 16 is a graph of the relationship between the tap water pressure (MPa) and the water discharge flow velocity (m/s) at four rotational positions R. FIG. 17 is a graph of the relationship between the rotation angle and the water discharge flow rate, and the relationship between the rotation speed and the water discharge flow velocity. In the measurement in FIG. 17, the tap water pressure was a pressure of 0.2 MPa. In FIG. 17, the value of the water discharge flow rate or the water discharge flow velocity is denoted at plotted points.

As illustrated in FIG. 15, on the water discharge flow rate, “cleaning shower” is almost equivalent to “sprinkling,” and lower than “shower.” On the other hand, as illustrated in FIG. 16, the water discharge flow velocity in “cleaning shower” is higher than in “shower.” As described above, “cleaning shower” achieves a high water discharge flow velocity at a small water discharge flow rate. Therefore, “cleaning shower” is excellent in the cleaning effect and the water saving effect. As illustrated in FIG. 15, although the water shape and the water discharge flow velocity are greatly different between “sprinkling” and “cleaning shower,” the water discharge flow rate is analogous. This shows the diversity of shower water discharge of the watering nozzle 100. Moreover, as illustrated in FIG. 16, in four types of shower water discharge, a variety of the water discharge flow velocity is achieved. This also shows the diversity of shower water discharge of the watering nozzle 100.

As illustrated in FIG. 17, in the transition from “cleaning shower” to “soft sprinkling,” a change in the water discharge flow velocity with respect to the rotation angle is relatively abrupt. On the contrary, in the transition from “soft sprinkling” to “shower,” a change in the water discharge flow rate with respect to the rotation angle is relatively gentle. This means that the water discharge flow rate is also not increased so much in the case where the water discharge flow velocity is increased in “cleaning shower,” and a high water saving effect is shown. Furthermore, in “cleaning shower,” a high water discharge flow velocity is achieved at a small water discharge flow rate, and a high cleaning effect is implemented.

As is also apparent from these items of data, advantages of the present invention are apparent.

The watering nozzle as described above can be used for any applications such as horticulture, cleaning, and car washing.

The description above is merely an example, and various modifications and alternations can be made within the scope and not deviating from the nature of the present invention.

What is claimed is:

1. A watering nozzle comprising:
an outer casing having a water discharge screen; and
an inner casing having a supply passage, wherein:
the water discharge screen has an inner region and an outer circumferential region;
the outer casing has a first passage communicating with the inner region, a second passage communicating with the outer circumferential region, and a screw portion;
the inner casing has a screw portion;
the screw portion of the outer casing and the screw portion of the inner casing form a screw coupling;
relative rotation between the outer casing and the inner casing causes the outer casing to make a relative displacement in a longitudinal direction with respect to the inner casing;
the relative displacement enables selection between a state in which water in the supply passage goes to the first passage and a state in which water in the supply passage goes to the second passage;
a shower hole is provided in the inner region; and
a discharge flow rate of water from the inner region changes continuously and/or in stages, based on the relative displacement.

2. The watering nozzle according to claim 1,
wherein a shower hole is provided in the outer circumferential region.

3. The watering nozzle according to claim 1,
wherein a discharge flow rate of water from the outer circumferential region changes continuously and/or in stages, based on the relative displacement.

4. The watering nozzle according to claim 1, wherein:
the water discharge screen further has an outer edge region located on an outer side of the outer circumferential region;
the outer edge region has an annular opening;
the outer circumferential region further has a straight hole;
the outer casing further has a third passage communicating with the outer edge region and a fourth passage communicating with the straight hole; and
the relative displacement enables selection between a state in which water in the supply passage goes to the first passage, a state in which water in the supply passage goes to the second passage, a state in which water in the supply passage goes to the third passage, and a state in which water in the supply passage goes to the fourth passage.

5. The watering nozzle according to claim 1,
wherein the discharge flow rate of water from the inner region continuously changes based on the relative displacement.

6. The watering nozzle according to claim 1,
wherein a range in which water discharged from the inner region reaches is narrower than a range in which water discharged from the outer circumferential region reaches regardless of a distance which water goes.
